(19) United States
(12) Patent Application Publication
(10) Pub. No.: US 2013/0218832 A1
(43) Pub. Date: Aug. 22, 2013

(54) Automated Collection and Aggregation of cross-platform and live event or in-person training records to support the conduct of clinical trials

(71) Applicants: Dave Young, Tucson, AZ (US); Alden Meier, Woodland Hills, CA (US)

(72) Inventors: Dave Young, Tucson, AZ (US); Alden Meier, Woodland Hills, CA (US)

(21) Appl. No.: 13/757,824

(22) Filed: Feb. 3, 2013

Related U.S. Application Data
(60) Provisional application No. 61/595,378, filed on Feb. 6, 2012.

(51) Int. Cl. G06F 17/30

(52) U.S. Cl. CPC G06F 17/3007
USPC 707/609

(57) ABSTRACT

The invention provides a system and method optimized for clinical trial training management. The inventive system and method collect training records across all training venues and platforms that are internal and external to any organization, provide a simple and efficient means to report on each and every training requirement and the satisfaction of training requirements for each clinical trial staff, and for each clinical trial site; and produce images of any and all certificates or records of attendance pertaining to satisfaction of any training requirement, thereby enabling clinical trial sponsor access to auditable records.

### RELATED APPLICATIONS

This application is related to and claims priority from U.S. provisional application 61/595,378 filed Feb. 6, 2012, and the entirety of said provisional application is incorporated by reference as if fully set forth herein. This application is also related to U.S. provisional application 61/595,613, filed Feb. 6, 2012, and the entirety of said application is incorporated by reference as if fully set forth herein. This application is also related to U.S. provisional application 61/654,915, filed Jun. 3, 2012, the entirety of which is incorporated by reference as if fully set forth herein. This application is also related to U.S. patent application Ser. Nos. 12/452,363; 12/449,791; 13/622,519, the entirety of each of which is incorporated by reference as if fully set forth herein.

### GOVERNMENT FUNDING

NONE

### FIELD OF USE

The invention is useful in the field of clinical trial management, and more specifically in the field of clinical trial personnel training record management in furtherance of improved conductance of clinical trials.

### BACKGROUND

Conventional Learning Management Systems (LMS) allow an organization to plan, deliver and manage training programs within an organization.

However, owing partly to the nature of how clinical trial training is acquired, conventional learning management systems fall short of satisfying all the training and documentation needs required to train and document the training of clinical trial staff in the most efficient manner.

Clinical trials require that physicians and support staff who are going to participate in those trials be trained on a specified curriculum of training, which curriculum is tailored to the specifics of the trial and to the role performed by the physician or staff in the trial. Every clinical trial provides for specific roles to be performed, and for each role that must be performed, clinical trial staff must be trained as to the specifics of their role. Moreover, all such training needs to be completed prior to starting to screen and enroll patients into the trial.

Currently, training physicians and support staff can occur across a multitude of systems and a variety of in-person events including but not limited to Investigator Meetings, Site Initiation Visits, remote Web based Conferences and on-demand, Web based training In all of these cases, supporting documentation such as a record of attendance or a certificate is issued to the attendee to provide a record of their training and to ensure that all of the necessary training for their role has been completed before they begin participating on the trial. On some clinical trials, a physician's training can occur across multiple in-person events and electronic systems. Each one of those training events generates a paper or electronic record or paper certificate of attendance which must be available to the Sponsor both for verification purposes, and in the event of an audit.

In addition, some training is useable across multiple studies for a given period of time. For example, Good Clinical Practice training may only need to be taken once every two years, depending on a Sponsors Standard Operating Procedures (SOPs). In this case, it is important to the physician to have their records available to the Sponsor so that the physician does not have to re-take training for which they already have valid credit.

One problem to be solved in improving clinical trial learning management system is handling the wide variety and source of the training records and providing an easy, auditable method for ensuring that all necessary training has been completed.

Another problem is the lack of a method for providing a centralized completion report for each person participating in the trial.

Completion of the required training for key staff is typically a pre-requisite for a site to start their participation in the trial by screening and enrolling patients. It is therefore very important to the sponsor—as well as the site—to make sure that training is completed and documented as quickly as possible.

The need for a centralized, easily accessible system where all of proof of training is stored is as important as completion of the required trainings

Current Learning Management Systems are not designed to collect training records across all training venues and platforms that are internal and external to the organization;
to provide a simple and efficient means to report on the training;
and to produce the certificate or record of attendance that was earned for the training

What is needed is a system and method optimized for clinical trial training management, where the system and method are designed to collect training records across all training venues and platforms that are internal and external to any organization as such;
to provide a simple and efficient means to report on each and every training requirement and the satisfaction of training requirements for each clinical trial staff, and for each clinical trial site; and to produce, upon request, images of any and all certificates or records of attendance pertaining to satisfaction of any training requirement, thereby enabling clinical trial sponsor access to auditable records.

What is needed is an improved method of tracking clinical trial training wherein collection of training records is agnostic as to form of record or data and record or data input mode. What is also needed is a method and system for storing clinical trial training records, such that reporting on training status, and monitoring readiness to launch clinical trial as a function of satisfaction of clinical trial training requirements is facilitated. What is further needed is a means to accurately produce, from stored training records data, an image of the precise certificate or other authenticating documents representing satisfaction of any portion of the required training for any clinical trial staff, including but not limited to physicians.

What is also needed is an optimal training requirement satisfaction determination for any potential clinical trial staff, including but not limited to physicians. For any clinical trial, the optimal training schedule for a potential staff member, where such an optimal training schedule take into account the staff personal training record, requirements already satisfied, as well as the variety of training options available for remaining requirements yet to be satisfied. Such an optimized training schedule provides for accurate record of requirements already satisfied, thereby eliminating training redundancies. Moreover, such a system provides the most efficient satisfaction of any remaining training requirements, ensuring as rapid and efficient as possible staff qualification to participate in the clinical trial. Such an optimized and personalized training protocol further aids in the rapid commencement of site and personnel qualification, while maintaining auditable records for use by the trial Sponsor.

### BRIEF SUMMARY OF THE INVENTION

The inventive system and method meets at least each of the above recited unmet needs.

The invention provides a system and method optimized for clinical trial training management, where the system and method are designed to collect training records across all training venues and platforms that are internal and external to any organization as such; to provide a simple and efficient means to report on each and every training requirement and the satisfaction of training requirements for each clinical trial staff, and for each clinical trial site; and to produce, upon request, images of any and all certificates or records of attendance pertaining to satisfaction of any training requirement, thereby enabling clinical trial sponsor access to auditable records.

The invention provides an improved method of tracking clinical trial training wherein collection of training records is agnostic as to form of record or data and record or data input mode. The invention further provides a method and system for storing clinical trial training records, such that reporting on training status, and monitoring readiness to launch clinical trial as a function of satisfaction of clinical trial training requirements is facilitated. The invention further provides for accurately producing, from stored training records data, an image of the precise certificate or other authenticating documents representing satisfaction of any portion of the required training for any clinical trial staff, including but not limited to physicians.

In one embodiment of the invention, the invention further provides an optimal training requirement satisfaction determination for any potential clinical trial staff, including but not limited to physicians. For any clinical trial, the optimal training schedule for a potential staff member, where such an optimal training schedule take into account the staff personal training record, requirements already satisfied, as well as the variety of training options available for remaining requirements yet to be satisfied. Such an optimized training schedule provides for accurate record of requirements already satisfied, thereby eliminating training redundancies. Moreover, such a system provides the most efficient satisfaction of any remaining training requirements, ensuring as rapid and efficient as possible staff qualification to participate in the clinical trial. Such an optimized and personalized training protocol further aids in the rapid commencement of site and personnel qualification, while maintaining auditable records for use by the trial Sponsor.

In one embodiment of the invention, the Sponsor can publish a list of training options and venues and allow the physician and site support staff to select the optimal training option based on their schedules and other commitments. Alternatively, the physician or staff can query the online training system to print out one's own training record, and an optimized potential training regimen from the training options available for to be satisfied training requirements. In this way, the invention provides a personalized, optimized training program for the clinical trial of interest.

### BRIEF DESCRIPTION OF THE DRAWINGS

Drawings to aid in the understanding of the invention are:

FIG. 1 depicts an embodiment of a system according to the invention.

FIG. 2 illustrates an example of physician profile mapping clinical trial training requirement record collection and aggregation according to the invention.

FIG. 3 illustrates an application of version change to Good Clinical Practice regulatory training module and depicts the application of a set of rules for re-training according to one embodiment of the invention.

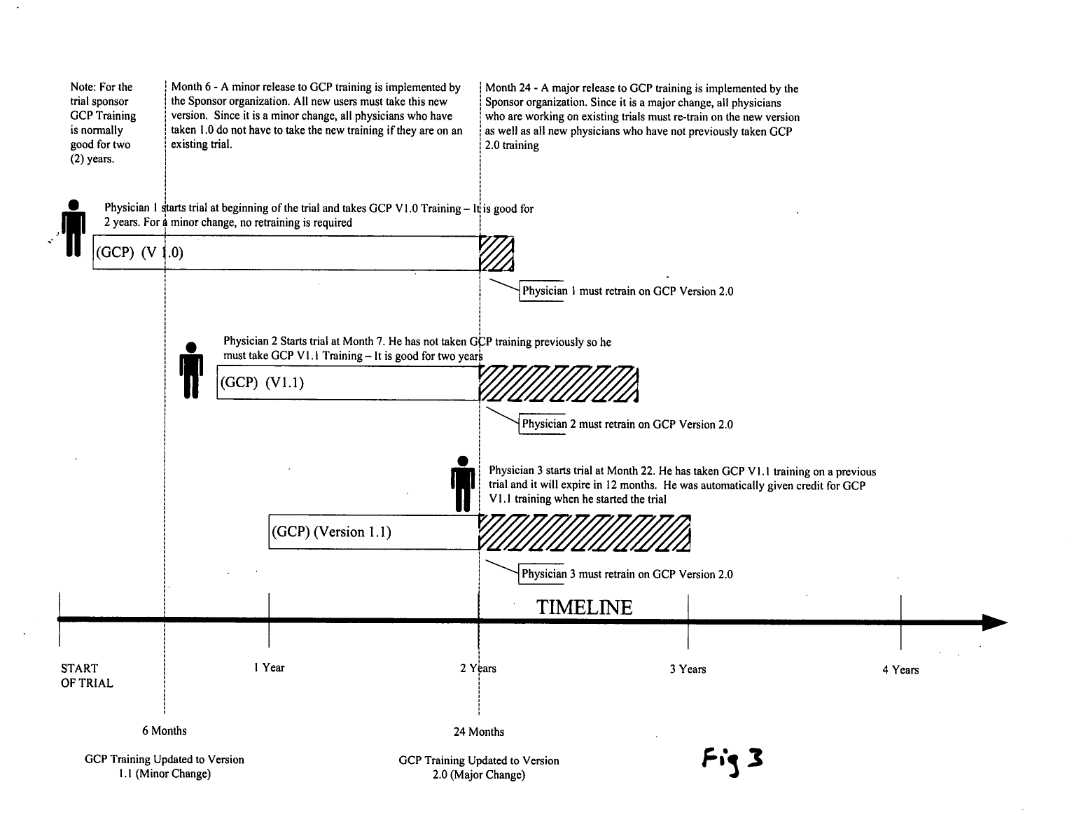

### DETAILED DESCRIPTION OF A PREFERRED EMBODIMENT

The invention taught herein provides a system and method optimized for collecting and storing electronic copies of all training records for all required training for a clinical trial. This includes supporting documentation such as certificates, records of participation and records of attendance for both physicians and site support staff participating in a clinical trial.

It can be appreciated without the need for further elaboration, that a system according to the invention does necessarily include input and output devices connected to or networked with a main computer, where the main computer has at least one Central Processing Unit (CPU), a memory and storage module, processing capabilities, and instructions implementable by the computer (software or firmware) to perform all the functions described herein. The inventive method is comprised of steps using input devices for inputting data, storing data, processing data, and outputting data, where interaction with the system is generally accomplished via one or more graphical user interfaces. A person of average skill in the relevant art requires no special explanation to comprehend how the invention works.

Some generalized examples are depicted in the figures filed herewith, and discussed later herein.

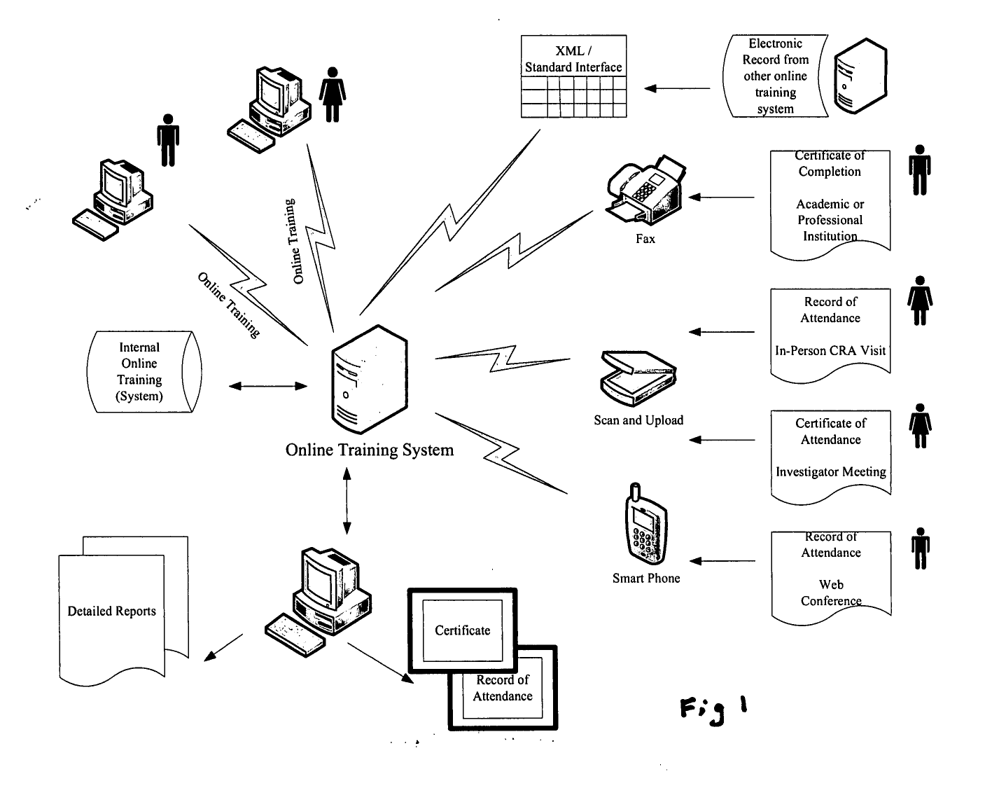

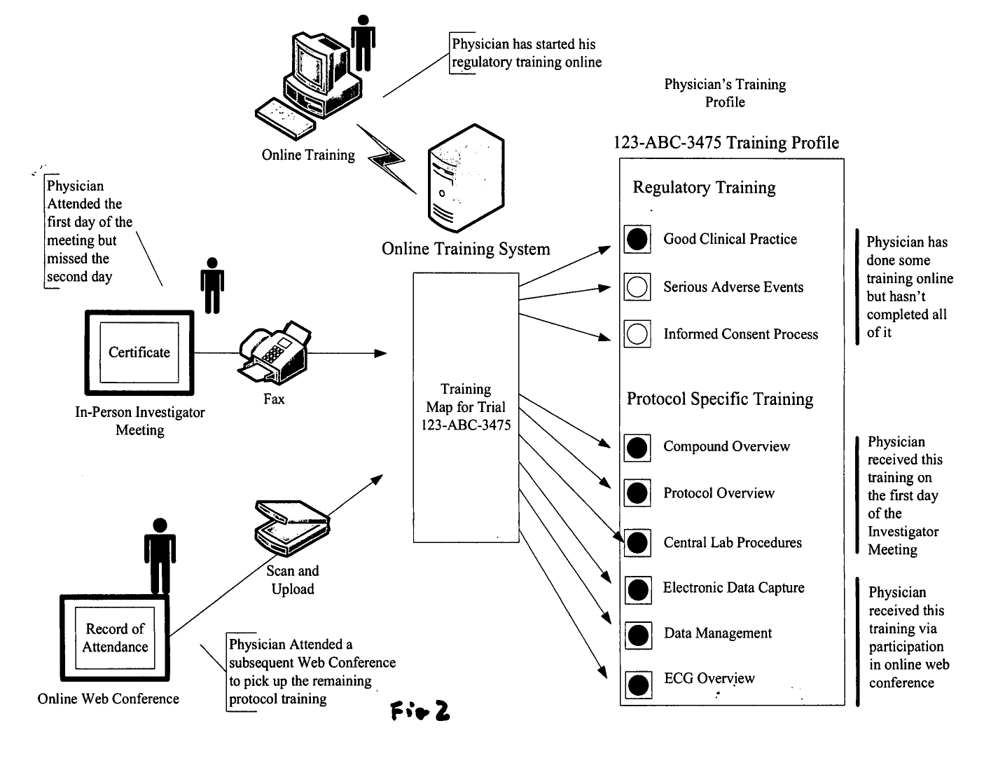

Clinical trial training records can include: electronic training records that are generated by the online training system (for example, ePresentOnline, and as described in U.S. patent application Ser. Nos. 12/452,363 and 12/449,791); system generated electronic training records from external training systems that are collected via a standard interface such as XML or other standards based data transfer mechanism; hard copy certificates or records of participation for in-person or other live events such as Investigator Meetings or activities such as site initiation visits. Paper or hard copy records are digitized via fax or scanner and uploaded into the system. Meta data is entered electronically using Quick Response Code (QR Code) or similar technologies, or is entered manually. FIG. 1 illustrates input devices (fax, scanner, smart phone, XML interface, online system, internal online system) from which records can be input into the central record storage. The central record storage maintains physician—and staff—profiles (see FIG. 2 for an exemplar of a training profile record according to an embodiment of the invention). Output from the central record storage (depicted in FIG. 1) include images of specific attendance certificates or training documentation (useful in audit or other documentation tasks) and reports detailing training status. It can be appreciated that reports may be assembled to summarize site training status (ex. how close is a site to satisfying training requirements for relevant personnel associated with a clinical) or individual or class of individuals (ex. a specific physician's training status, or, a particular role or roles, described in the trial protocol (ex. nurses).

As depicted in FIG. 2, a system according to the invention collects all these types of training record and stores them on the appropriate physician or support staff's training profile. The system contains a mapping of all of the various methods and events that qualify as approved training for the clinical trial and maps them to specific training modules. This mapping provides a mechanism for the system to compile a trial training profile for each participant based on all of the training records in the system for that participant. Equivalencies are mapped as well so that if a Web Conference covers all of the required training, the system can mark complete all of the mapped training once a user provides their certificate of participation. If a physician or support staff misses part of the training at the in-person event—only partial attendance is documented—the system can grant credit for only those topics that were covered during the attendance period.

As the training period progresses, the system evaluates the training records available for each participant and builds a trial profile for the user determining equivalencies as well as determining which training has yet to be taken. The Study Team and any other internal compliance groups can access the system and can review detailed or summary reports on the status of each participant and their associated site to determine any follow-up that is required. Reports are generated that indicate what training each participant has taken and the method in which they took the training Electronic copies of the certificates and records of attendance can be accessed and viewed by compliance personnel for verification. (depicted in FIG. 1).

Users who have not provided adequate training records for the training are required to take their remaining training at a scheduled event or are required to take the training online in order to complete all of the necessary training prior to their participation in the trial.

Hereinbelow, we provide an example of how the invention works.

A physician and her site are contracted to participate in a clinical trial. In order to participate, the physician and her main support person, a nurse, are required to take the designated regulatory training as well as protocol specific training before starting to screen and enroll patients.

The physician was involved in another clinical trial six months previously and completed all of the required regulatory training on that earlier study. Her nurse is new to clinical trials but does belong to an accredited institution, the Association of Clinical Research Professionals (ACRP) and has a paper certificate for Good Clinical Practices from that institution.

In order to participate, both the physician and her nurse must complete the required training or prove that they have equivalent training that is current and acceptable to the Sponsor. The physician's regulatory training records are already in the system because she trained on the internal training system on the previous study. The nurse hasn't trained on the internal system and must scan and upload a copy of her ACRP certificate or print a QR Coded fax cover sheet and fax a copy of the certificate to the system which will be associated with her training profile. Since the nurse hasn't participated in a trial previously, she will also have to complete all of the other regulatory training which can include privacy, serious adverse events, source documentation, informed consent process, et cetera using the online system.

Since both the Physician and the nurse are on a new trial, both must also complete protocol specific training which can include Compound Overview, Protocol Overview, Central Lab training and other training The physician attends an In-Person Investigator Meeting while the nurse is unable to attend. The physician receives a paper certificate of attendance after the Investigator Meeting which indicates her attendance at the required training The nurse on the other hand participates in a Web Conference and also receives a paper certificate of participation which indicates her attendance at the required training In addition, a backup nurse at the site will be participating in the trial and takes his training using the online training system via the Internet. He takes all of the regulatory training as well as the Protocol Specific training online. His training completion is recorded in the online system and one or more certificates are issued from the system.

The physician and the nurse log into the Online Training System and upload a scanned copy of their paper certificates for the Protocol Specific training into the system. The system stores the electronic copies on their training accounts and updates their training records to indicate that they have in fact completed all of their required Protocol Specific training for the trial. The backup nurse doesn't have to do anything since his records were captured in the system as he completed his training online. The system flags the nurse's record to indicate that she still needs to complete the rest of her regulatory training but grants her credit for the GCP certificate that she faxed into the system. The nurse must then log into the online training system and complete the other required regulatory training

Once the nurse has completed all of her training, the system flags the site as ready for their Site Initiation Visit where a qualified CRA visits the site and reviews all documentation as well as provides any additional training Once the Site Initiation Visit is complete, the site can proceed to screen and enroll patients into the study.

In an enhanced version, the Sponsor can publish a list of training options and venues and allow the physician and site support staff to select the optimal training option based on their schedules and other commitments.

We claim:

1. An improved system for collecting, maintaining and analyzing training records associated with clinical trial training requirements, in a networked system of computing device, central processing unit, memory and storage, and computer implementable instructions for accomplishing data storage, maintenance and analysis, and where said data stored include user profiles, where users are recipients of clinical trial training, where said improvement comprises:
form-independent input of training records, so that training record of any electronic or non-electronic form is received, and information stored in the appropriate user profile;
current user-profiles, where said user profile includes a map of training, where said map is further identified by clinical trial number, and where the training status of users are indicated based on input of training records; and
stored images of training certificates input as training records, so that training status of users is amenable to audit and verification.

2. An improved method for collecting, maintaining and analyzing training records associated with clinical trial training requirements, wherein said method is performed by means of a networked system comprising at least one computing device, central processing unit, memory and storage, and computer implementable instructions for accomplishing data storage, maintenance and analysis, and where said data stored include user profiles, where users are recipients of clinical trial training, where said improvement comprises the steps of:
inputting training records in form-independent manner, so that training record of any electronic or non-electronic form are received, and training information stored in the appropriate user profile;
maintaining user status, where user training status is mapped under a numerically identified clinical trial, and user training record of regulatory and protocol specific training is maintained; and
storing images of training certificates input as training records, so that training status of users is amenable to audit and verification.
